(19) United States
(12) Patent Application Publication
(10) Pub. No.: US 2015/0277434 A1
(43) Pub. Date: Oct. 1, 2015

(54) PRODUCTION PLAN CREATION SUPPORT METHOD AND PRODUCTION PLAN CREATION SUPPORT APPARATUS

(71) Applicant: FUJITSU LIMITED, Kawasaki-shi (JP)

(72) Inventors: Hirotaka ITO, Kasugai (JP); Tatsuya ISHIHARA, Yokohama (JP); Jun FUKAO, Ichinomiya (JP)

(73) Assignee: FUJITSU LIMITED, Kawasaki-shi (JP)

(21) Appl. No.: 14/630,788

(22) Filed: Feb. 25, 2015

(30) Foreign Application Priority Data
Mar. 28, 2014 (JP) 2014-070540

(51) Int. Cl. G05B 19/4097

(52) U.S. Cl. CPC G05B 19/4097

(57) ABSTRACT

A non-transitory computer-readable recording medium stores a program for causing a computer to execute a process. The process includes extracting a work object and a plurality of setup change objects included in a bucket from a Gantt chart in which the bucket including the work object and the plurality of setup change objects is included; calculating a total time allocated for the extracted plurality of setup change objects; and displaying the extracted work object and a setup change object indicated by the calculated total time in a row in the bucket.

### CROSS-REFERENCE TO RELATED APPLICATIONS

This application is based upon and claims the benefit of priority of the prior Japanese Patent Application No. 2014-070540, filed on Mar. 28, 2014, the entire contents of which are incorporated herein by reference.

### FIELD

The embodiments discussed herein are related to a production plan creation support program, a production plan creation support method, and a production plan creation support apparatus.

### BACKGROUND

There have conventionally been software applications for displaying a Gantt chart and editing work objects on the Gantt chart to manage a production plan of products or the like. Among such software applications, there is one which can display a production plan in units of buckets on the Gantt chart. The bucket is provided to collectively manage a plurality of work objects, instead of individually managing the work periods of the work objects. The bucket has a set period and is associated with work objects to be implemented in that period.

Patent Literature 1: Japanese Laid-open Patent Publication No. 2008-152381 is introduced as the Prior Art Document.

If different products are produced in a single set of facilities, a setup change is sometimes performed. A setup change refers to setup work performed on facilities to switch items to be produced. For example, suppose that a set of facilities performs work identified by a first work object and then performs work identified by a second work object. In such a case, an operation for changing tools for manufacturing target products of the first work object to those for manufacturing target products of the second work object may be performed as a setup change. A setup change may also include preparation of materials, machines, tools, drawings, and the like, and/or prototyping before a start of work.

A bucket can include a lot of small pieces of work. Such a bucket can also include a lot of small pieces of setup changes. If the setup changes included in the bucket are displayed in small pieces, it is difficult to comprehend how much time of the bucket is occupied by the setup changes.

### SUMMARY

According to an aspect of an embodiment, a non-transitory computer-readable recording medium stores a program for causing a computer to execute a process. The process includes extracting a work object and a plurality of setup change objects included in a bucket from a Gantt chart in which the bucket including the work object and the plurality of setup change objects is included; calculating a total time allocated for the extracted plurality of setup change objects; and displaying the extracted work object and a setup change object indicated by the calculated total time in a row in the bucket.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a general configuration of an entire system;

FIG. 2 is a diagram illustrating an example of a functional configuration of a production plan creation support apparatus;

FIG. 3 is a diagram illustrating an example of a data configuration of work information;

FIG. 4 is a diagram illustrating an example of a data configuration of bucket information;

FIG. 5 is a diagram illustrating an example of a production plan screen displaying a production plan;

FIG. 6 is a diagram illustrating an example of the production plan screen displaying the production plan;

FIG. 7 is a diagram illustrating an example of the production plan screen displaying the production plan;

FIG. 8 is a flow chart illustrating an example of a procedure of display control processing; and

FIG. 9 is diagram illustrating a computer that executes a production plan creation support program.

### DESCRIPTION OF EMBODIMENTS

Preferred embodiments of the present invention will be explained with reference to accompanying drawings. The embodiments herein are not intended to limit the scope of the invention. The embodiments can be combined appropriately as long as the various types of processes performed in the embodiments are not contradictory to each other.

### [a] First Embodiment

Configuration of System

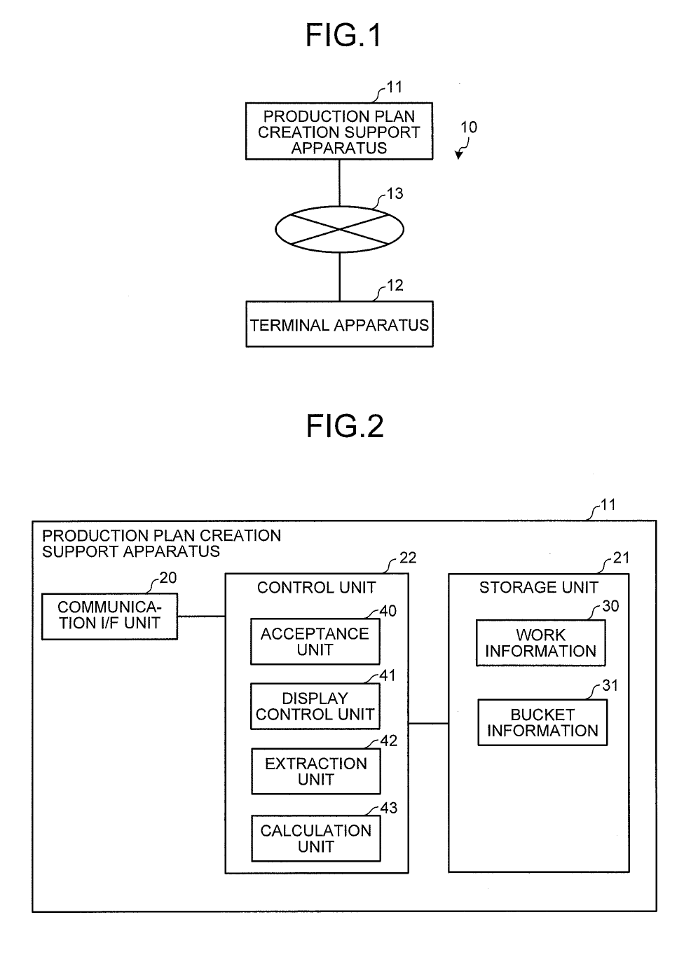

A system 10 according to a first embodiment will be described. FIG. 1 is a diagram illustrating an example of a general configuration of the entire system. As illustrated in FIG. 1, the system 10 is a system that supports the creation of a production plan of products or the like. The system 10 includes a production plan creation support apparatus 11 and a terminal apparatus 12. The production plan creation support apparatus 11 and the terminal apparatus 12 are configured to be able to exchange various types of information. For example, the production plan creation support apparatus 11 and the terminal apparatus 12 are communicably connected via a network 13 so that various types of information can be exchanged. As a mode of such a network 13, any type of communication network, whether wired or wireless, may be employed. Examples thereof may include mobile communications such as a mobile phone, the Internet, a LAN (Local Area Network), and a VPN (Virtual Private Network).

The terminal apparatus 12 is a computer which an administrator who creates and manages a production plan uses to input and refer to a production plan. Examples of the terminal apparatus 12 may include a desktop PC (personal computer) and a notebook PC. The administrator uses the terminal apparatus 12 to transmit various operation instructions concerning a production plan to the production plan creation support apparatus 11, so as to create a production plan by using the production plan creation support apparatus 11. While the example of FIG. 1 illustrates a case where there is one terminal apparatus 12, this is not restrictive. The number of terminal apparatuses 12 may be arbitrary.

The production plan creation support apparatus 11 is an apparatus that performs various types of processing concerning a production plan. Examples of the production plan creation support apparatus 11 may include a computer such as a server computer. The production plan creation support apparatus 11 may be implemented as a single computer or may be implemented as a cloud of a plurality of computers. For example, the production plan creation support apparatus 11 may be implemented by an application server that performs various types of processing concerning a production plan and a database server that stores various types of information concerning the production plan. The production plan creation support apparatus 11 may be implemented as a standalone apparatus operated directly by the administrator. The present embodiment will be described by using a case where the production plan creation support apparatus 11 is a single computer as an example. The production plan creation support apparatus 11 runs software applications for supporting the creation of a production plan, and performs processing according to requests received from the terminal apparatus 12. The production plan creation support apparatus 11 then generates information about processing results, such as image information about a result of performing processing, and transmits the information to the requesting terminal apparatus 12.

Configuration of Production Plan Creation Support Apparatus

Next, a configuration of the production plan creation support apparatus 11 according to the present embodiment will be described. FIG. 2 is a diagram illustrating an example of a functional configuration of the production plan creation support apparatus. As illustrated in FIG. 2, the production plan creation support apparatus 11 includes a communication I/F (interface) unit 20, a storage unit 21, and a control unit 22. The production plan creation support apparatus 11 may include various known functional units in addition to the functional units illustrated in FIG. 2. For example, the production plan creation support apparatus 11 may include an input unit that inputs various types of information, and/or a display unit that displays various types of information.

The communication I/F unit 20 is an interface for performing communication control with other apparatuses. The communication I/F unit 20 transmits and receives various types of information to/from other apparatuses via the network 13. For example, the communication I/F unit 20 receives various operation instructions concerning a production plan from the terminal apparatus 12. The communication I/F unit 20 transmits image information about a result of performing processing according to operation instructions to the terminal apparatus 12. A network interface card such as a LAN card may be employed as the communication I/F unit 20.

The storage unit 21 is a storage device that stores various types of data. Examples of the storage unit 21 may include storage devices such as a hard disk, an SSD (Solid State Drive), and an optical disk. Note that the storage unit 21 may be a data-rewritable semiconductor memory such as a RAM (Random Access Memory), a flash memory, and an NVSRAM (Non Volatile Static Random Access Memory).

The storage unit 21 stores an OS (Operating System) and various programs to be executed by the control unit 22. For example, the storage unit 21 stores various programs including a production plan creation support program for performing display control processing to be described later. The storage unit 21 further stores various types of data used by the programs executed by the control unit 22. For example, the storage unit 21 stores work information 30 and bucket information 31.

The work information 30 is data that contains information about various types of work to be performed by the production plan. For example, the work information 30 contains information about items to be produced, facilities for performing the work, a period of work, and the like with respect to each piece of work to be performed.

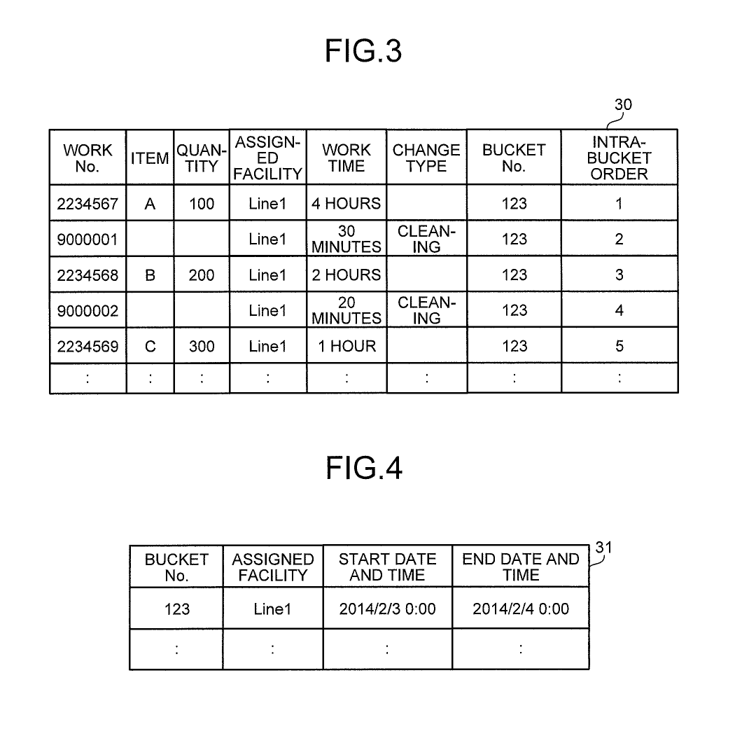

FIG. 3 is a diagram illustrating an example of a data configuration of the work information. As illustrated in FIG. 3, the work information 30 includes respective fields of “work No.,” “item,” “quantity,” “assigned facility,” “work time,” “change type,” “bucket No.,” and “intra-bucket order.” The ‘work No.’ field is an area in which identification information for identifying work is stored. Unique work Nos. are assigned to respective pieces of work as identification information for identifying the respective pieces of work. A work No. assigned to the work is stored in the ‘work No.’ field. The ‘item’ field is an area in which information indicating the item to be produced by the work is stored. Information such as an item code indicating the item is stored in the ‘item’ field. The ‘quantity’ field is an area in which the quantity of items to be produced by the work is stored. The ‘assigned facility’ field is an area in which information indicating a facility to be used to perform the work is stored. In the present embodiment, information about a production line that produces a product is used as the information indicating the facility. The ‘work time’ field is an area in which a scheduled work time is stored. The ‘change type’ field is an area in which the type of a setup change is stored. For example, the type of a setup change indicates a piece of work performed as setup change. Examples thereof may include various types of work such as a cleaning operation and a tool change. If the work is for a setup change, information indicating the type of the setup change is stored in the ‘change type’ field. If the work is for item production, the ‘change type’ field is blank. The ‘bucket No.’ field is an area in which identification information for identifying the bucket including the work is stored if the work is managed in a bucket. Unique bucket Nos. are assigned to buckets as identification information for identifying the respective buckets. A bucket No. assigned to the bucket is stored in the ‘bucket No.’ field. The ‘intra-bucket order’ field is an area in which information indicating the order of pieces of work in a bucket is stored. Note that the work information 30 may include other fields to be set. For example, the work information 30 may include the deadline of manufacturing of the work, a possible start date of manufacturing, a field for setting work needed to be completed before the work, and a field for setting work to be started later.

In the example of FIG. 3, work No. “2234567” indicates that the work is to produce items “A” as many as the quantity “100” in the assigned facility “Line1.” Work No. “2234567” also indicates that the work time is “4 hours.” The blank in the ‘setup change’ field indicates that the work is for production. Work No. “2234567” also indicates that the bucket including the work has a bucket No. of “123” and intra-bucket order of “1.” Work No. “9000001” includes blanks in the ‘item’ and ‘quantity’ fields, and indicates that the assigned facility of the work is “Line1.” Work No. “9000001” has a work time of “30 minutes.” “Cleaning” in the ‘change type’ field indicates that the work is setup change work for cleaning. Work No. “9000001” also indicates that the bucket including the work has a bucket No. of “123” and intra-bucket order of “2.”

Referring back to FIG. 2, the bucket information 31 is data that contains information about a bucket or buckets. For example, the bucket information 31 contains information about facilities, a period, and the like of/in which work is managed as a bucket.

FIG. 4 is a diagram illustrating an example of a data configuration of the bucket information. As illustrated in FIG. 4, the bucket information 31 includes “bucket No.,” “assigned facilities,” “start date and time,” and “end date and time” fields. The ‘bucket No.’ field is an area in which a bucket No. for identifying the bucket is stored. The ‘assigned facility’ field is an area in which information indicating the facility of which work is managed by using the bucket is stored. In the present embodiment, information about a production line for producing products is used as the information indicating the facility. The ‘start date and time’ field is an area in which the start date and time of a period in which work is managed as a bucket is stored. The ‘end date and time’ field is an area in which the end date and time of the period is which the work is managed as a bucket is stored.

In the example of FIG. 4, bucket No. “123” indicates that the assigned facility of which work is managed by using the bucket is “Line1,” the start date and time of the management period is “2014 Feb. 3 0:00,” and the end date and time of the management period is “2012 Feb. 4 0:00.”

Referring back to FIG. 2, the control unit 22 is a device that controls the production plan creation support apparatus 11. Electronic circuits such as a CPU (Central Processing unit) and an MPU (Micro Processing Unit) and integrated circuits such as an ASIC (Application Specific Integrated Circuit) and an FPGA (Field Programmable Gate Array) may be employed as the control unit 22. The control unit 22 includes an internal memory for storing programs and control data that define various processing procedures, and thereby performs various types of processing. With the operation of various programs, the control unit 22 functions as various processing units. For example, the control unit 22 includes an acceptance unit 40, a display control unit 41, an extraction unit 42, and a calculation unit 43.

The acceptance unit 40 performs various types of acceptance. For example, the acceptance unit 40 accepts various operation instructions concerning a production plan. For example, the acceptance unit 40 accepts various operation instructions concerning a production plan transmitted from the terminal apparatus 12.

The display control unit 41 performs display control on various screens. For example, the display control unit 41 makes the terminal apparatus 12 display various screens concerning a production plan. For example, the display control unit 41 makes the terminal apparatus 12 display a production plan screen displaying a production plan of products and the like in the form of a Gantt chart. The display control unit 41 then updates the production plan screen to be displayed on the terminal apparatus 12 according to an operation instruction accepted by the acceptance unit 40.

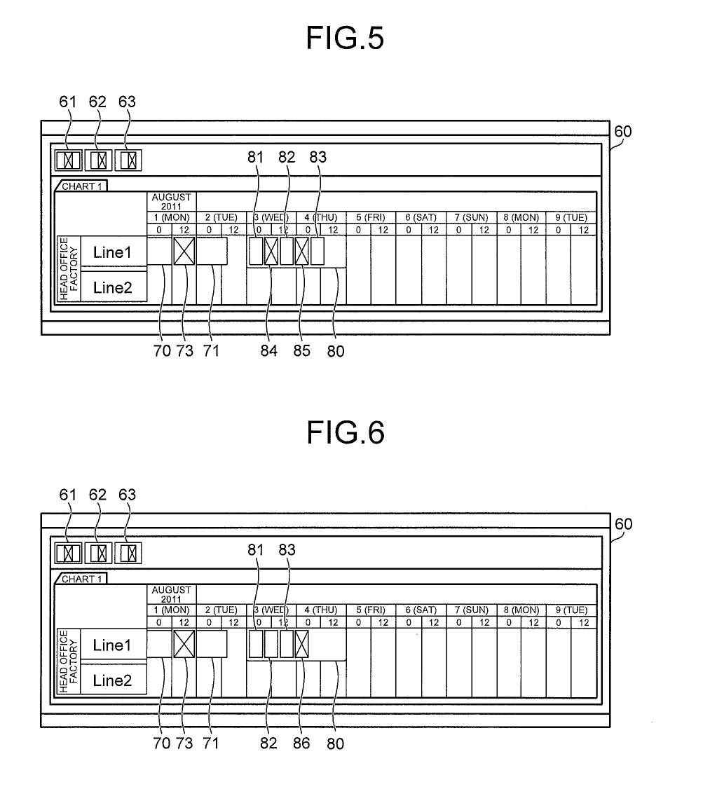

A description will be given by using a specific example. FIG. 5 is a diagram illustrating an example of the production plan screen displaying a production plan. The production plan screen 60 illustrated in FIG. 5 includes a display area displaying a Gantt chart in which work objects indicating scheduled pieces of work are laid out for each production line. The display area displays product plans of the assigned facilities Line1 and Line2. In the example of FIG. 5, work objects 70 and 71 representing work for producing items and a bucket 80 are displayed on the assigned facilities Line1. A setup change object 73 representing setup change work is displayed between the work objects 70 and 71. The bucket 80 is intended to collectively manage the pieces of work from 2014 Feb. 3, 0:00 to 2014 Feb. 4, 0:00. The bucket 80 includes work objects 81, 82, and 83 representing work for producing items. Setup change objects 84 and 85 representing setup change work are displayed between the work objects 81, 82, and 83.

The production plan screen 60 includes command buttons for performing various operations at the top of the screen. In the example of FIG. 5, only command buttons related to the present embodiment are illustrated at the top of the screen, which include three command buttons 61 to 63. The command button 61 is a button for giving an instruction that the work times of the setup change work in the bucket be individually displayed between the respective work objects to perform a setup change. The command button 62 is a button for giving an instruction that the work times of the setup change work in the bucket be collectively displayed after the last work object in the bucket. The command button 63 is a button for giving an instruction that the work times of the setup change work in the bucket be collectively displayed at the end of the bucket.

Referring back to FIG. 2, the display control unit 41, if the command button 61 is selected, displays the setup change objects 84 and 85 between the work objects 81, 82, and 83 in the bucket 80 as illustrated in FIG. 5.

The extraction unit 42 performs various types of extraction. For example, if the command button 62 or 63 is selected, the extraction unit 42 extracts the work objects and the setup change objects included in the bucket displayed on the production plan screen 60. For example, the extraction unit 42 refers to the bucket information 31 and identifies the bucket No. of the bucket displayed on the production plan screen 60. The extraction unit 42 then extracts the records concerning the work objects and the setup change objects of which the identified bucket No. is registered in the ‘bucket No.’ field.

The calculation unit 43 performs various calculations. For example, the calculation unit 43 calculates, bucket by bucket, the sum of the work times allocated for setup changes in the bucket. For example, the calculation unit 43 sums up the work times registered in the ‘work time’ field of the records of the setup change objects extracted by the extraction unit 42 to calculate a total work time bucket by bucket.

If the command button 62 is selected, the display control unit 41 displays the pieces of work and a piece of setup change work indicating the total work time of the setup changes in a row in the bucket. For example, if the command button 62 is selected, the display control unit 41 arranges the work objects of the respective pieces of work in the bucket 80 in the order of the intra-bucket order, with sizes according to the work periods of the respective pieces of work. The display control unit 41 then displays a setup change object indicating the total work time after the last work object, with a size according to the total work time.

On the other hand, if the command button 63 is selected, the display control unit 41 arranges the work objects of the respective pieces of work in the bucket 80 in the order of the intra-bucket order, with the sizes according to the work periods of the respective pieces of work. The display control unit 41 then displays the setup change object indicating the total work time at the end of the bucket, with the size according to the total work time.

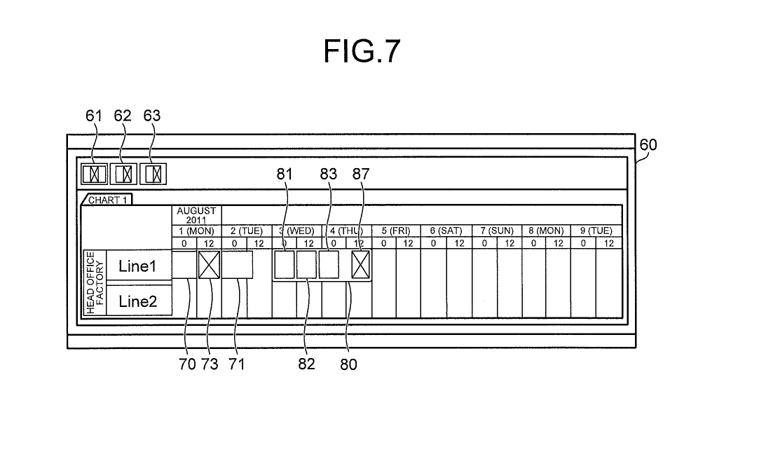

FIGS. 6 and 7 are diagrams illustrating examples of the production plan screen displaying a production plan. FIG. 6 illustrates the result when the command button 62 is selected on the production plan screen 60 illustrated in FIG. 5. In the example of FIG. 6, the work objects 81, 82, and 83 are successively displayed in order in a row in the bucket 80. A setup change object 86 indicating the total work time of the setup changes is displayed after the last work object 83. FIG. 7 illustrates the result when the command button 63 is selected on the production plan screen 60 illustrated in FIG. 5. In the example of FIG. 7, the work objects 81, 82, and 83 are displayed in order in a row in the bucket 80. A setup change object 87 indicating the total work time of the setup changes is displayed at the end of the bucket 80.

When a plurality of pieces of work are managed in a bucket, a typical index for plan evaluation is whether the amount of work assigned to the bucket is appropriate. In view of this, setup changes are a loss. If the loss is too large, the administrator reviews the work assigned to the bucket. The total loss resulting from setup changes is difficult to comprehend if the setup changes between the pieces of work in the bucket are individually displayed. Displaying a setup change object indicating the total work time of the setup changes in the bucket can make the loss in the bucket easier to comprehend.

If an idle period in which the facility is not operated or does not perform production is set for each facility, the display control unit 41 may display the idle period in an identifiable manner. For example, if an idle period is set in which a factory is at rest, like during nighttime, the display control unit 41 may display the idle period in an identifiable manner. If an idle period is included in the period of a bucket, the display control unit 41 displays work objects and a setup change object(s) in the proportions of the respective work periods to the period excluding the idle period. If an idle period is included in the period of a bucket, the display control unit 41 may display an object indicting the idle period. As a result, the administrator can comprehend the proportions of the respective work periods to the substantial workable period which is the period of the bucket excluding the idle period.

### Flow of Processing

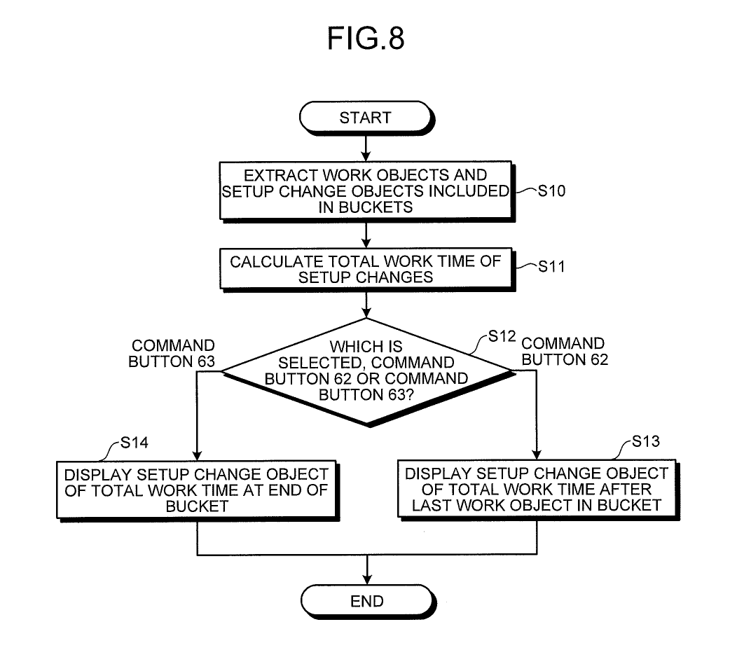

A flow of the display control processing in which the production plan creation support apparatus 11 according to the present embodiment displays a setup change object indicating the total work time of setup changes in a bucket will be described. FIG. 8 is a flow chart illustrating an example of a procedure of the display control processing. The display control processing is performed at predetermined timing, for example, at timing when the command button 62 or the command button 63 is selected on the production plan screen 60.

As illustrated in FIG. 8, the extraction unit 42 extracts work objects and setup change objects included in buckets displayed on the production plan screen (S10). For example, the extraction unit 42 refers to the bucket information 31 to identify the bucket Nos. of the buckets displayed on the production plan screen. The extraction unit 42 then extracts records concerning the work objects and the setup change objects of which the identified bucket Nos. are registered in the ‘bucket No.’ field.

The calculation unit 43 sums up, bucket by bucket, the work times of the setup changes included in the bucket to calculate a total work time (S11). The display control unit 41 determines whether the selected command button is the command button 62 or the command button 63 (S12). If the command button 62 is selected, the display control unit 41 arranges the work objects of the respective pieces of work in the bucket in the order of the intra-bucket order. The display control unit 41 displays a setup change object indicating the total work time after the last work object (S13), and ends the processing. On the other hand, if the command button 63 is selected, the display control unit 41 arranges the work objects of the respective pieces of work in the bucket in the order of the intra-bucket order. The display control unit 41 displays the setup change object indicating the total work time at the end of the bucket (S14), and ends the processing.

### Effect

As has been described above, the production plan creation support apparatus 11 according to the present embodiment extracts work objects and a plurality of setup change objects included in a bucket from a Gantt chart in which the bucket including the work objects and the plurality of setup change objects is included. The production plan creation support apparatus 11 calculates a total time allocated for the extracted plurality of setup change objects. The production plan creation support apparatus 11 displays the extracted work objects and a setup change object indicated by the calculated total time in a row in the bucket. In such a manner, the production plan creation support apparatus 11 can display the time occupied by setup changes in an easily viewable manner in units of buckets. This allows the administrator to easily comprehend the occurrence of losses.

The production plan creation support apparatus 11 according to the present embodiment displays the setup change object indicated by the total time after the last work object included in the bucket. The production plan creation support apparatus 11 can thus display a remaining period in which no work is performed in the bucket in an easily viewable manner. This facilitates the administrator reviewing what work can be assigned to the bucket on the basis of the remaining period.

The production plan creation support apparatus 11 according to the present embodiment also displays the setup change object indicated by the total time at the end of the period corresponding to the bucket. The production plan creation support apparatus 11 can thus separately display the work time used to produce items and the work time used for setup changes in an easily viewable manner. This allows the administrator to easily comprehend in what proportions time is allocated for the production of items and for the setup changes in the bucket, and facilitates reviewing what work can be assigned to the bucket.

### [b] Second Embodiment

Up to this point, an embodiment of the production plan creation support apparatus according to the disclosure has been described. However, the disclosed technique may be carried out in various forms other than the foregoing embodiment. Another embodiment encompassed by the present invention will be described below.

For example, the foregoing embodiment has dealt with the case where the production plan creation support apparatus 11 expresses the work periods by objects in the bucket. However, the production plan creation support apparatus according to the disclosure is not limited thereto. For example, the production plan creation support apparatus may display the periods of the respective objects along with the objects.

The foregoing embodiment has dealt with the case where if the command button 62 or the command button 63 is selected, a setup change object indicating the total work time of setup changes included in a bucket is displayed in the bucket. However, the production plan creation support apparatus according to the disclosure is not limited thereto. For example, a state in which the command button 62 or the command button 63 is selected may be initially displayed on the production plan screen 60. In other words, a setup change object indicating the total work time of setup changes included in a bucket may be initially displayed in the bucket on the production plan screen 60.

Note that the components of the apparatuses illustrated in the drawings are functional, conceptual ones, and do not need to be physically configured as illustrated in the drawings. That is, the specific states of the apparatuses, whether distributed or integrated, are not limited to the illustrated ones. All or part of the apparatuses may be configured to be functionally or physically distributed or integrated in arbitrary units according to various loads and use conditions. For example, processing units including the acceptance unit 40, the display control unit 41, the extraction unit 42, and the calculation unit 43 may be integrated as appropriate. The processing of each processing unit may be divided into that of a plurality of processing units as appropriate. All or any part of processing functions performed by the processing units may be implemented by a CPU and a program interpreted and executed by the CPU. All or any part of such processing functions may be implemented as hardware by wired logic.

### Production Plan Creation Support Program

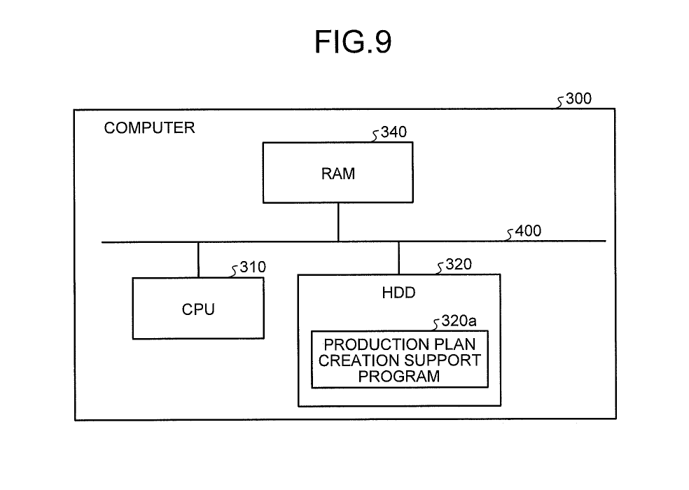

Various types of processing described in the foregoing embodiments may be implemented by running a prepared program on a computer system such as a personal computer and a workstation. An example of the computer system that executes a program having the same functions as those of the foregoing embodiments will be described below. FIG. 9 is a diagram illustrating a computer that executes a production plan creation support program.

As illustrated in FIG. 9, a computer 300 includes a CPU (Central Processing Unit) 310, an HDD (Hard Disk Drive) 320, and a RAM (Random Access Memory) 340. These units 300 to 340 are connected together via a bus 400.

A production plan creation support program 320a which provides the same functions as those of the foregoing acceptance unit 40, display control unit 41, extraction unit 42, and calculation unit 43 is stored in the HDD 320 in advance. Note that the production plan creation support program 320a may be divided as appropriate.

The HDD 320 stores various types of information. For example, the HDD 320 stores an OS and various types of data used for the estimation of a moving direction to a terminal to be tracked.

The CPU 310 reads the production plan creation support program 320a from the HDD 320 and executes the production plan creation support program 320a to perform the same operations as those of the processing units according to the foregoing embodiment. In other words, the production plan creation support program 320a performs the same operations as those of the acceptance unit 40, the display control unit 41, the extraction unit 42, and the calculation unit 43.

The production plan creation support program 320a described above does not necessarily need to be stored in the HDD 320 from the beginning.

For example, the program may be stored in a “portable physical medium” to be inserted into the computer 300, such as a flexible disk (FD), a CD-ROM, a DVD disk, a magneto-optical disk, and an IC card. The computer 300 may read the program from such a medium and execute the program.

The program may be stored in “another computer (or server)” or the like connected to the computer 300 via a public line, the Internet, a LAN, a WAN, or the like. The computer 300 may read the program from such a computer (or server) and execute the program.

According to an aspect of the present invention, the time occupied by setup changes in units of a bucket can be displayed in an easily viewable manner.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process, the process comprising:
extracting a work object and a plurality of setup change objects included in a bucket from a Gantt chart in which the bucket including the work object and the plurality of setup change objects is included;
calculating a total time allocated for the extracted plurality of setup change objects; and
displaying the extracted work object and a setup change object indicated by the calculated total time in a row in the bucket.

2. The computer-readable recording medium according to claim 1, wherein the displaying includes displaying the setup change object indicated by the total time after a last work object included in the bucket.

3. The computer-readable recording medium according to claim 1, wherein the displaying includes displaying the setup change object indicated by the total time at an end of a period corresponding to the bucket.

4. A production plan creation support method comprising:
extracting, using a processor, a work object and a plurality of setup change objects included in a bucket from a Gantt chart in which the bucket including the work object and the plurality of setup change objects is included;
calculating, using a processor, a total time allocated for the extracted plurality of setup change objects; and
displaying, using a processor, the extracted work object and a setup change object indicated by the calculated total time in a row in the bucket.

5. An apparatus for production plan creation, the apparatus comprising:
a processor that executes a process comprising:
extracting a work object and a plurality of setup change objects included in a bucket from a Gantt chart in which the bucket including the work object and the plurality of setup change objects is included;
calculating a total time allocated for the extracted plurality of setup change objects; and
a displaying the extracted work object and a setup change object indicated by the calculated total time in a row in the bucket.
